(19) United States
(12) Patent Application Publication
(10) Pub. No.: US 2018/0215237 A1
(43) Pub. Date: Aug. 2, 2018

(54) SYSTEM AND METHOD FOR HVAC OUTLET FLOW CONTROL VENT USING ELECTRICALLY RESPONSIVE VANES

(71) Applicant: GM Global Technology Operations LLC, Detroit, MI (US)

(72) Inventor: Kamil BALCERZAK, Royal Oak, MI (US)

(21) Appl. No.: 15/421,897

(22) Filed: Feb. 1, 2017

(51) Int. Cl. B60H 1/34

(52) U.S. Cl. CPC B60H 1/3414; B60H 2001/3471

(57) ABSTRACT

A system is disclosed for controlling a direction of a fluid flow. The system may include a vent for channeling the fluid flow. The vent may have a vane supported within the vent, with at least a portion of the vane formed from an electrically responsive material. The vane may assume a first shape when no electrical signal is applied thereto, and may deform into a second shape when an electrical signal is applied thereto. An electrical signal source electrically coupled to the vane to apply an electrical signal to the vane. A controller may control the application of the electrical signal to the vane to control a shape of the vane in a manner that causes the vane to direct the fluid flow in different directions.

### FIELD

The present disclosure relates to systems and methods for controlling a fluid flow through a vent or port using electrically responsive vanes.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In vehicles such as cars and trucks, an instrument panel of the vehicle includes use of a plurality of vents through which cool or hot air may be directed by a define heating/ventilation/air conditioning (HVAC) system into a passenger cabin. The vents are typically spaced apart on the instrument panel to disperse the cold or heated airflow throughout the passenger cabin. The vents typically include a plurality of vanes that are mounted to a frame. The vents may have a joystick that an occupant can move either left to right and/or up and down to move the vanes. The vanes adjust the direction of airflow leaving the vent.

However, the joystick partially blocks airflow through the vent. In addition, the user may need to repeatedly adjust the vanes to optimize airflow within the passenger compartment of the vehicle.

### SUMMARY

In one aspect the present disclosure relates to a system for controlling a direction of a fluid flow. The system may comprise a vent for channeling the fluid flow into a defined area. A vane supported within the vent may include at least a portion formed from an electrically responsive material that assumes a first shape when no electrical signal is applied thereto, and which may deform into a second shape when an electrical signal is applied thereto. An electrical signal source electrically coupled to the vane may be used to apply an electrical signal to the vane. A controller that controls the application of the electrical signal to the vane may also be used to control a shape of the vane in a manner that causes the vane to direct the fluid flow in different directions.

In another aspect the present disclosure relates to a system for controlling a direction of a fluid flow. The system may comprise a vent for channeling the fluid flow into a defined area. The vent may include a plurality of vanes supported within the vent. Each vane may include at least a portion formed from an electroactive polymer that enables each vane to assume a first shape when no electrical signal is applied thereto, and to deform into a second shape when an electrical signal is applied thereto. The vent may also include a direct current (DC) signal source electrically coupled to each of the vanes which applies an electrical signal to each of the vanes, and a controller that controls the application of the electrical signals to the vanes to cause the vanes to alternately deform and return to an un-deformed state, to direct the fluid flow in different directions.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a simplified block diagram of a motor vehicle instrument panel showing a pair of vents in accordance with one example of the present disclosure, which may be associated with an HVAC system of the vehicle, and where each of the vents include a deformable vane in accordance with the present disclosure;

FIG. 2 is a block diagram showing various components that may be used to control the shape of the vane(s) of the vent;

FIGS. 3-5 show a simplified side view of one vane within the vent illustrating various shapes the vane may be deformed into to control a direction of airflow through the vent;

FIG. 6 illustrates one example of a deformable vane of the present disclosure being used to completely block off one flow path in a conduit and while opening a different flow path, and thus acting as a flow directing valve; and

FIG. 7 shows a plan view of one example of a vane that is comprised partially of an electrically responsive material and partially of a non-electrically responsive material.

In the drawings, reference numbers may be reused to identify similar and/or identical elements.

### DETAILED DESCRIPTION

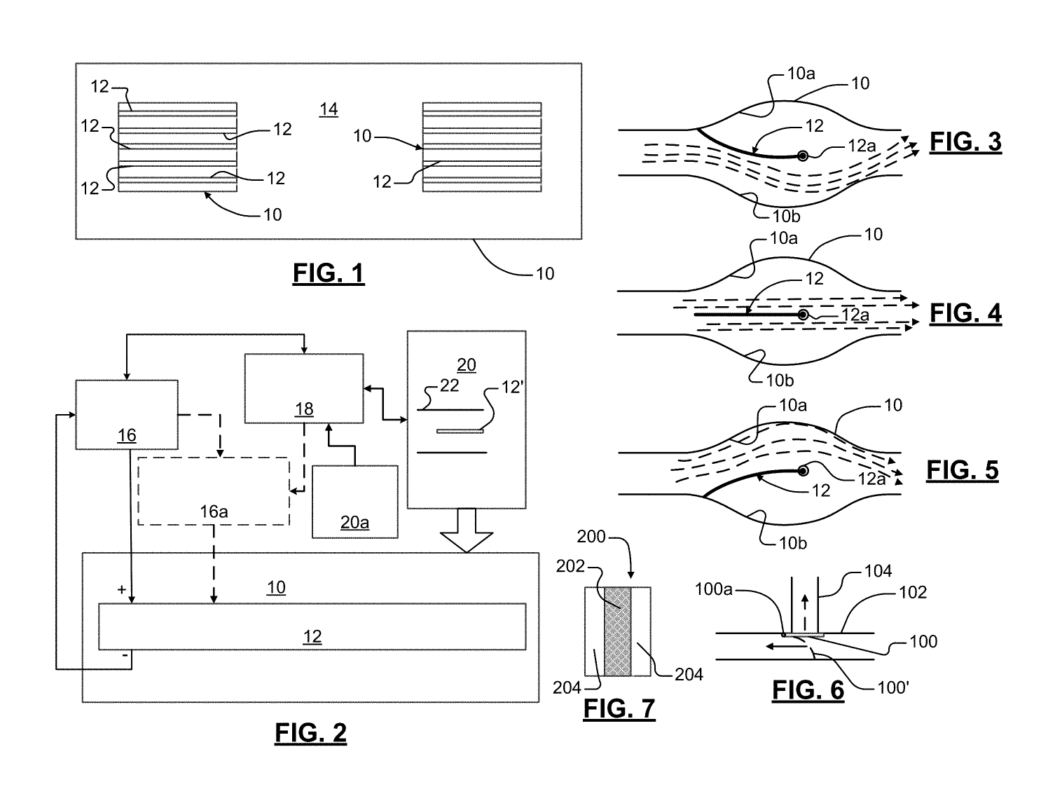

Referring to FIG. 1, a plurality of vents 10 include a plurality of vanes 12 in accordance with one example of the present disclosure. In this example two vents 10 are shown mounted in an instrument panel of the vehicle, although the vents 10 may be mounted in a dashboard, a headliner or any other desired location where hot and/or cold air from a vehicle heating/ventilation/air conditioning (HVAC) system needs to be supplied. While two vents 10 have been illustrated, the present disclosure is not limited to any particular number of vents 10 and/or vanes 12. The vents 10 each channel a fluid flow (e.g., hot air and/or cold air) into a predefined area such as a passenger compartment of a motor vehicle.

In some examples, the vanes 12 are constructed in whole or in part from an electrically responsive material such as an electroactive polymer. The quantity of electroactive polymer is sufficient to allow the vanes 12 to bend when an electrical signal, such as a direct current (DC) signal, is applied across each of the vanes. Depending on how each vane 12 is constructed, for example, how the electroactive polymer is deployed when constructing the vanes 12, the manner in which the vanes 12 bend or deform can be controlled. The amount or degree of deformation may also be controlled by the magnitude of the DC signal applied across each vane 12. Since a characteristic of electroactive polymers is that they return to an initial shape when the electrical signal is removed, this enables an oscillating motion to be achieved when the DC signal is applied in an intermittent or pulse-like fashion to the vane 12. Electroactive polymers may be obtained from a variety of companies, for example Danfoss PolyPower A/S of Nordborg, Denmark; EAMEX Corporation of Osaka, Japan; Environmental Robots, Inc. of Albuquerque, N. Mex.; LEAP Technology of Lyngby, Denmark; and Nanosonic, Inc. of Blacksburg, Va.

In some examples, the electroactive polymer may be combined with other non-electrically responsive materials when constructing the vanes 12, or alternatively a section or subportion of a vane 12 is formed from the electroactive polymer. The section formed using the electroactive polymer may be located at an area of the vane 12 that enables the desired deformation or bending of the vane when a DC signal is applied to the vane.

Referring to FIG. 2, the deformation of the vane 12 may be controlled by controlling the application of an electrical signal, in this example a DC voltage from a DC signal source 16, across the vane 12. The DC signal source 16 may be a positive or negative voltage source, or it may be able to supply both positive and negative DC signals. The DC signal source 16 may be turned on and off as needed to achieve the desired movement (i.e., deformation) of the vane 12. The DC signal source 16 may be controlled by an engine controller 18 which also may control operation of an HVAC system 20 of a vehicle in which the vent 10 is being used. Optionally, the engine controller may be an Engine Control Unit (ECU) of the vehicle. An intermediate switching network 16a is also optional. If the intermediate switching network 16a is included it may be controlled by the engine controller 18 and located between the DC signal source 16 and the vane 12, and used to control the application of the DC voltage at different times to different ones of the vanes. Thus, some vanes 12 could be maintained in their “rest” state (i.e., un-deformed state) while other vanes are electrically activated to be deformed. Optionally, a user engageable electronic switch 20a may be electrically interfaced to the engine controller 18 to enable a user to turn on and off one or more of the vents 10, and thus have a degree of control over the direction of airflow within the passenger cabin. The electronic switch 20a may also enable the user to select one or more groups of vanes 12 within a given vent 10 that are electrically energized, or possibly to command all the vents to remain wide open or to be completely closed.

It is also contemplated that some implementations of the vanes 12 may be located within one or more ducts 22 forming the HVAC system 20, as indicated by vane 12′. In this manner, one or more of the vanes 12′ may be used to control routing of both hot and cold air through various ducts of the HVAC system 20.

Referring to FIGS. 3-5, simplified side views of one of the vanes 12 are shown to illustrate how the vane 12 may be deformed to control the direction of airflow through the vent 10. In FIGS. 3-5 the vane 12 is shown supported at point 12a. FIG. 3 shows how the vane 12 may be deformed to contact an upper interior wall portion 10a of the vent 10, which helps to direct the airflow out from the vent 10 in an upwardly direction. FIG. 4 shows the vane 12 in its un-deformed or “rest” state, which allows the airflow to be directed straight out from the vent 10. FIG. 5 shows the vane 12 in a downwardly deformed state abutting lower interior wall portion 10b of the vent 10, which results in the airflow exiting the vent in a downwardly direction. As noted above, the direction of bending movement of the vane 12 may be achieved by the specific construction of the vane or by how the vane is mounted in the vent 10. Stiff further, the direction of the airflow out from each vent 10 may be tailored in part by the curvature of the interior walls portions 10a and 10b. The interior wall portions 10a and 10b may be formed in a manner that works in connection with a shape of the vane 12 to help to channel an airflow through the vent 10 in one, two or more different directions, depending on the shape of the vane 12. Optionally, alternately using both a negative DC voltage and a positive DC voltage may achieve a bending motion of the vane 12 in different directions. Accordingly, it will be appreciated that simply varying the polarity of the DC signal from positive to negative, when applying the DC signal to the vanes 12, may be sufficient to cause two different deformations of the same vane 12.

FIG. 6 illustrates a vane 100 in accordance with another embodiment of the present disclosure where the vane is secured to an interior wall of a conduit 102 at point 100a. In one orientation (shown in solid lines) the vane 100 operates to completely block off a fluid flow (e.g., air) into a separate section of conduit 104. But when electrically excited, the vane 100 deforms (i.e., bends), as represented by dashed line 100′, to open the flow path into the conduit 104 while blocking flow through the conduit 102. Thus, the vane 100 operates as a directional valve. The vane 100 may be used to control a flow of virtually any type of fluid, provided the specific material selected for the vane 100 is compatible with the fluid being controlled. Thus, the vane 100′ may be used to control a direction of flow of air, gas, or even a liquid.

FIG. 7 illustrates a vane 200 in accordance with another embodiment of the present disclosure where the vane is made only in part from an electrically responsive material. Portion 202 comprises the electrically responsive material, which may be for example an electroactive polymer or any other electrically responsive material. Portions 204 may be made from non-electrically responsive material, for example plastic or metal.

In automotive applications it is expected that the vane 12 may be used to automatically control an airflow out of the vent 10 in a manner that causes the airflow to be directed laterally back and forth from the driver side to the passenger side within the passenger cabin of the vehicle, in an oscillating manner, to more evenly disperse either hot air or cold air within the passenger cabin. A significant advantage is that since no graspable element needs to be located on the vent 10 for the operator to adjust, airflow through the vent is not obstructed. This enables an even smaller area vent to be used to achieve a degree of airflow comparable to a larger vent that requires the conventional graspable portion for manual vent adjustment. The electronic switch 20a may enable a user to apply the same signal (e.g. close vent) to all of the vents using just a single command, for example a single touch command on a touchscreen.

The vanes 12 can be integrated into existing vent structures with only minimal modifications being required. Furthermore, the vanes 12 do not significantly complicate the construction of the vent 10 and/or add appreciably to the overall cost of the vehicle's HVAC system, or to the weight of the vehicle.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A system for controlling a direction of a fluid flow, comprising:
a vent for channeling the fluid flow into a defined area;
a vane supported within the vent and including at least a portion formed from an electrically responsive material that assumes a first shape when no electrical signal is applied thereto, and which deforms into a second shape when an electrical signal is applied thereto;
an electrical signal source electrically coupled to the vane to apply an electrical signal to the vane; and
a controller that controls the application of the electrical signal to the vane to control a shape of the vane in a manner that causes the vane to direct the fluid flow in different directions.

2. The system of claim 1, wherein the electrically responsive material comprises an electroactive polymer.

3. The system of claim 1, wherein the electrical signal source forms a direct current (DC) signal source for generating a DC signal.

4. The system of claim 1, wherein the controller comprises an engine control unit (ENGINE CONTROLLER).

5. The system of claim 1, further comprising a heat, ventilation, air conditioning (HVAC) system for supplying a fluid flow to the vent.

6. The system of claim 1, wherein the fluid flow comprises an air flow.

7. The system of claim 1, wherein the vane comprises a first portion which includes the electrically responsive material, and a second portion which is made from a non-electrically responsive material.

8. A system for controlling a direction of a fluid flow, comprising:
a vent for channeling the fluid flow into a defined area:
a plurality of vanes supported within the vent, each said vane including at least a portion formed from an electroactive polymer that enables each said vane to assume a first shape when no electrical signal is applied thereto, and to deform into a second shape when an electrical signal is applied thereto;
a direct current (DC) signal source electrically coupled to each of the vanes to apply an electrical signal to each of the vanes; and
a controller that controls the application of the electrical signals to the vanes to cause the vanes to alternately deform and return to an un-deformed state, to direct the fluid flow in different directions.

9. The system of claim 8, wherein the vanes each include:
a first portion formed from the electroactive polymer; and
a second portion formed from a non-electrically responsive material.

10. The system of claim 8, wherein the electronic controller comprises an engine control unit.

11. The system of claim 8, wherein the vent and the vanes form a portion of a heating, ventilation and air conditioning (HVAC) system of a motor vehicle.

12. The system of claim 8, further comprising an electronic switch in communication with the electronic controller which enables a user to input a command to control an operation of the vent.

13. The system of 8, wherein the vent includes at least one interior wall portion that is shaped to work in connection with the vane to help channel air in a predetermined direction.
